(19) United States
(12) Patent Application Publication
(10) Pub. No.: US 2016/0031298 A1
(43) Pub. Date: Feb. 4, 2016

(54) VEHICLE DOOR SASH HAVING VERTICAL PILLAR SASH

(71) Applicant: SHIROKI CORPORATION, Kanagawa (JP)

(72) Inventors: Jiro YOSHIHARA, Kanagawa (JP); Isami MITUHASHI, Kanagawa (JP)

(73) Assignee: SHIROKI CORPORATION, Kanagawa (JP)

(21) Appl. No.: 14/781,944

(22) PCT Filed: Apr. 3, 2014
(86) PCT No.: PCT/JP2014/059819

§ 371 Date: Oct. 2, 2015

(30) Foreign Application Priority Data
Apr. 5, 2013 (JP) 2013-079607

(51) Int. Cl. B60J 5/04; B62D 27/02

(52) U.S. Cl. CPC B60J 5/0402; B60J 5/0422; B62D 27/02

(57) ABSTRACT

Provided is a door sash having a vertical pillar sash for vehicle that does not cause a problem of blowout when the vertical pillar sash is formed by welding a plurality of steel sheets.

A vehicle door sash is characterized by having a vertical pillar sash and including an inner member and an outer member, on which overlapped portions are respectively formed to thereby form a pocket-like portion. One of the inner member and the outer member includes a bent portion which is continuous with associated the overlapped portion. At least part of a sheet-thickness end face of the other of the inner member and the outer member is in contact with the bent portion, and the bent portion and the sheet-thickness end face are laser-welded at the contact portion.

### TECHNICAL FIELD

The present invention relates to a vehicle door sash having a vertical pillar sash which is configured by welding a plurality of steel sheets.

### BACKGROUND ART

A vertical pillar sash of a vehicle door sash is generally provided with a pocket-like portion and a design portion formed by joining steel sheets together. The pocket-like portion has a closed cross section which is positioned on the vehicle interior side, and the design portion is positioned on the vehicle exterior side. The pocket-like portion of this vertical pillar sash is conventionally made by joining portions of two steel sheets, which overlap each other, by hemming (Patent Literature 1). In addition, welding (spot welding/arc welding) is known in the art as a different method of joining portions of two steel sheets which overlap each other.

A raw (non-plated) steel material (generally a cold-rolled steel sheet (JIS-SPCC)) has been generally used as a steel material for use in making the vertical pillar sash of a vehicle door sash; however, in order to prevent the vertical pillar sash from rusting, it has been attempted to form at least one of the two steel sheets, which are joined by welding, from a plated steel sheet on which zinc is plated (Patent Literature 2).

### CITATION LIST

### Patent Literature

Patent Literature 1: Japanese Unexamined Patent Publication No. 2008-302788
Patent Literature 2: Japanese Unexamined Patent Publication No. 2008-290129

### SUMMARY OF INVENTION

### Technical Problem

However, hemming requires a large pressure to deform and fold one of the overlapped portions of the two steel sheets when these are joined together, which easily deforms the two steel sheets. On the other hand, the possibility of the steel sheets being deformed by welding is smaller than that by hemming. However, out of various types of steel sheets, plated steel sheets in particular have the problem of zinc vapor emerging and causing damage to the welding electrode (impairing the durability of the welding electrode) if the steel sheets are spot-welded. Whereas, in arc welding using a welding rod, there is no possibility of the durability of the welding electrode being impaired; however, there is the problem of blowout easily occurring due to zinc vapor emerging during welding.

An object of the present invention is to obtain a vehicle door sash having a vertical pillar sash, wherein a pocket-like portion can be formed by welding without use of hemming, which is generally used conventionally, when the pocket-like portion is formed by joining portions of two steel sheets which overlap each other.

In addition, an object of the present invention is to obtain a vehicle door sash having a vertical pillar sash, wherein welding marks do not appear outwardly or can be easily hidden.

Additionally, an object of the present invention is to obtain a vehicle door sash having a vertical pillar sash, wherein the problem of blowout does not arise when a plurality of plated steel sheets are welded to form the vertical pillar sash.

### Solution to Problem

The present invention includes a vehicle door sash characterized by having a vertical pillar sash and including an inner member and an outer member, on which overlapped portions are respectively formed to thereby form a pocket-like portion. One of the inner member and the outer member includes a bent portion which is continuous with associated the overlapped portion. At least part of a sheet-thickness end face of the other of the inner member and the outer member is in contact with the bent portion, and the bent portion and the sheet-thickness end face are laser-welded at the contact portion.

Since the bent portion and the sheet-thickness end face of the inner and outer members are laser-welded at the aforementioned contact portion, no welding marks appear outwardly or can be easily hidden by a glass run, etc.

The bent portion can be formed on the outer member, and a welding area between the inner member and the outer member can include contact portions of a surface of the bent portion of the outer member on the inner member side and the sheet-thickness end face of the inner member that are in contact with each other. Alternatively, the bent portion can be formed on the inner member, and a welding area between the inner member and the outer member can include contact portions of a surface of the bent portion of the inner member on the outer member side and the sheet-thickness end face of the outer member which are in contact with each other.

At least one of the inner member and the outer member can be made of a plated steel sheet.

Since the sheet-thickness end face is not sufficiently plated, blowout does not easily occur upon the sheet-thickness end face being welded, which improves the weldability of the sheet-thickness end face and the bent portion, thus making it possible to achieve durable and high-precision welding.

A spaced portion, which causes the inner member and the outer member to be in noncontact with each other between the bent portion and the overlapped portions, can be formed on the one of the inner member and the outer member that includes the bent portion, and the bent portion can be bent and extend toward the other of the inner member and the outer member that does not include the bent portion from the spaced portion.

In addition, a contact portion and a noncontact portion which are in contact and noncontact with the bent portion, respectively, can be formed on the sheet-thickness end face.

A clearance exists between the inner member and the outer member or between the contact portion and the noncontact portion due to the formation of the spaced portion, so that blowout does not easily occur.

### Advantageous Effects of Invention

According to the present invention, in a vehicle door sash in which overlapped sheet portions that constitute a pocket-like portion are formed on the aforementioned inner and outer member, the shape of a portion to be laser-welded is appropriately determined before laser welding is performed, so that the pocket-like portion can be formed without using hemming, and no welding marks outwardly appear or can be easily hidden, which makes it possible to achieve a vehicle door sash having a vertical pillar sash which is superior in outward appearance.

### BRIEF DESCRIPTION OF DRAWINGS

FIG. 1 is a side elevational view of an embodiment of a vehicle door sash having a vertical pillar sash which is formed by laser-welding a plated steel sheet and a plated steel sheet to each other according to the present invention;

FIG. 2 is a cross sectional view taken along the line II-II shown in FIG. 1, illustrating a first embodiment of the vertical pillar sash according to the present invention;

FIG. 3 is a cross sectional view of the first embodiment shown in FIG. 2 in a laser welded state;

FIG. 4 is a cross sectional view of a second embodiment of the vertical pillar sash;

FIG. 5 is a cross sectional view of the second embodiment of the vertical pillar sash, taken at a different position, in the vertical direction, from that in FIG. 4;

FIG. 6 is a cross sectional view of a third embodiment of the vertical pillar sash; and

FIG. 7 is a cross sectional view of a fourth embodiment of the vertical pillar sash.

### DESCRIPTION OF EMBODIMENTS

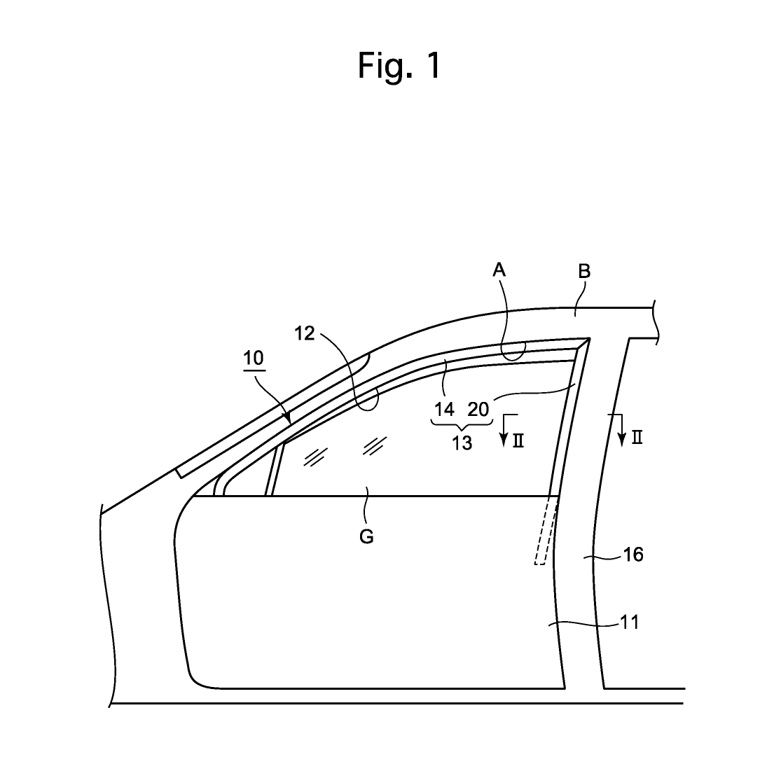

FIG. 1 shows a side shape of a motor vehicle including a vehicle door 10. The vehicle door 10, which is for opening and closing a door opening (body opening) A of a vehicle body B, is provided with a door sash (window frame) 13, which forms a window opening 12 on top of a door body (including an inner panel and an outer panel) 11.

The door sash 13 is provided with an upper sash 14 and a vertical pillar sash 20. The upper sash 14 is formed into a curved shape in a side view to receive the upper edge of a window glass G, and the vertical pillar sash 20 extends along a center pillar 16 of the vehicle body B to receive the vertical edge of the window glass G. The upper end of the vertical pillar sash 20 and an end of the upper sash 14 are connected and fixed to each other by a known method, and lower parts of the vertical pillar sash 20 and the upper sash 14 extend into the inside of the door body 11 and are fixed thereto. In the present embodiment, the present invention has been applied to the vertical pillar sash 20 of the door sash 13.

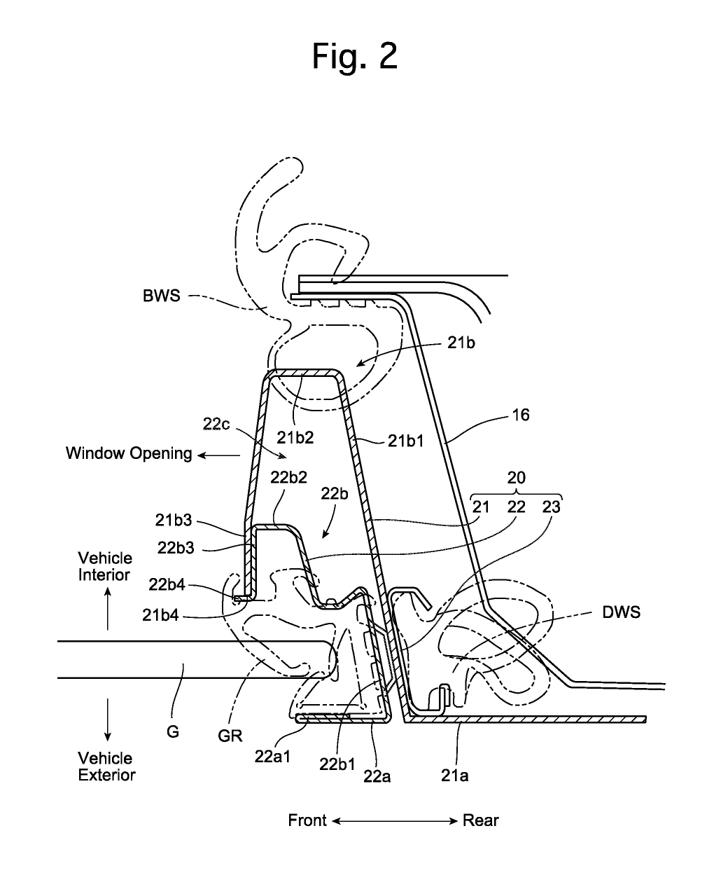

As shown in FIG. 2, the vertical pillar sash 20 is provided with an inner member (main vertical pillar member) 21, an outer member (sub-vertical pillar member) 22 and a weather strip retaining member 23. Out of these members, each of the inner member 21 and the outer member 22 is made of galvanized steel sheet, while the weather strip retaining member 23 is made of raw steel sheet (cold-rolled steel sheet (JIS-SPCC)). The weather strip retaining member 23 can be omitted, and a weather strip can be fixed to the inner member 21 using clips. The thickness of the inner member (galvanized steel sheet) 21 is greater than the thickness of the outer member (raw steel sheet) 22.

The inner member 21 is provided with a design portion 21a which is positioned on the vehicle exterior side and a folded-back portion 21b which extends toward the vehicle interior side from the design portion 21a. The folded-back portion 21b is provided with a vehicle-interior-side extension portion 21b1 which extends obliquely toward the vehicle interior from the design portion 21a, a forward/rearward extension portion 21b2 which extends toward the window opening from the end of the vehicle-interior-side extension portion 21b1 on the vehicle interior, and a vehicle-exterior-side extension portion 21b3 which extends toward the vehicle exterior from the end of the forward/rearward extension portion 21b2 on the window opening side.

The outer member 22 is provided with a design portion 22a which is positioned on the vehicle exterior side, and a folded-back portion 22b which extends from the design portion 22a toward the vehicle interior side. The folded-back portion 22b is provided with a vehicle-interior-side extension portion 22b1 which extends obliquely toward the vehicle interior along the vehicle-interior-side extension portion 21b1, a closed-cross-section (pocket-like portion) forming portion 22b2 which extends stepwise toward the window opening 12 from the end of the vehicle-interior-side extension portion 22b1, and a vehicle-exterior-side extension portion 22b3 which extends toward the vehicle exterior side from the end of the closed-cross-section forming portion 22b2 on the window opening 12 side along the vehicle-exterior-side extension portion 21b3. The folded-back portion 21b (the vehicle-interior-side extension portion 21b1, the forward/rearward extension portion 21b2 and the vehicle-exterior-side extension portion 21b3) of the inner member 21 and the folded-back portion 22b (the closed-cross-section forming portion 22b2) of the outer member 22 constitute a pocket-like portion 22c having a closed cross sectional shape. The end of the design portion 22 on the window opening side is formed as a folded-back intimate-contact portion 22a1.

(The folded-back portion 21b (the vehicle-interior-side extension portion 21b1, the forward/rearward extension portion 21b2 and the vehicle-exterior-side extension portion 21b3) of the inner member 21 and the folded-back portion 22b (the vehicle-interior-side extension portion 22b1, the closed-cross-section forming portion 22b2 and the vehicle-exterior-side extension portion 22b3) of the outer member 22 constitute a pocket-like portion 22c having a closed cross sectional shape.) The end of the vehicle-exterior-side extension portion 21b3 of the inner member 21 on the vehicle exterior side and the end of the vehicle-exterior-side extension portion 22b3 of the outer member 22 on the vehicle exterior side constitute overlapped portions (overlapped sheet portions) which overlap each other so as to close the pocket-like portion 22c. The vehicle-interior-side extension portion 22b1 of the outer member 22 is provided, at different positions thereon at predetermined intervals in the vertical direction of the vehicle-interior-side extension portion 22b1, with a plurality of welding seats 22b11 which project toward the vehicle interior side from the window opening side. The vehicle-interior-side extension portion 22b1 and the plurality of welding seats 22b11, and the vehicle-interior-side extension portion 21b1 of the inner member 21 constitute overlapped portions (overlapped sheet portions) which overlap each other so as to close the pocket-like portion 22c. It is possible to overlap the vehicle-interior-side extension portions 21b1 and 22b1 on each other to form a plate portion without forming the plurality of welding seats 22b11 on the vehicle-interior-side extension portion 22b1. The vehicle-interior-side extension portions 21b1 and 22b1 can be formed as overlapped portions which are directly overlapped onto each other. Alternatively, welding seats can be provided on the vehicle-interior-side extension portion 21b1 side of the inner member 21.

In the descriptions of the present embodiment, out of the two members which constitute the pocket-like portion 22c of the vertical pillar sash 20, the member positioned on the vehicle inner side (the member designated by the reference numeral 21) is referred to as the inner member and the member positioned on the vehicle exterior side (the member designated by the reference numeral 22) is referred to as the outer member; however, out of the two members which constitute the pocket-like portion 22c, the member positioned outside the overlapped portions (the member designated by the reference numeral 21) can be referred to as the outer member and the member positioned inside the overlapped portions (the member designated by the reference numeral 22) can be referred to as the inner member.

The weather strip retaining member 23 is a channel member which retains a door-side weather strip DWS, and the weather strip retaining member 23, the vehicle-interior-side extension portion 21b1 of the inner member 21 and the vehicle-interior-side extension portion 22b1 of the outer member 22 are joined together by welding (e.g., spot welding). The door-side weather strip DWS and a body-side weather strip BWS which is supported by the vehicle body B are compressed between the vehicle door 10 and the center pillar 16 of the vehicle body B and between the vehicle door 10 and the vehicle-interior-side extension portion 21b1 of the inner member 21 to prevent rain water from entering the vehicle body B when the vehicle door 10 is closed.

The design portion 22a and the folded-back portion 22b of the outer member 22 constitute a glass-run holding recess which holds a glass run GR. The glass run GR guides a window glass G for opening and closing the window opening 12 as known in the art. The end of the vehicle-exterior-side extension portion 22b3 on the vehicle exterior side is formed as a bent portion (bent sheet portion) 22b4, and a vehicle-exterior-side sheet-thickness end face (trim edge) 21b4 of the vehicle-exterior-side extension portion 21b3 of the inner member 21 faces the surface of the bent portion 22b4, on the vehicle interior side thereof. When the window glass G is driven to move up and down to open and close the window opening 12, force in the vehicle width direction is exerted on the glass run GR. The bent portion 22b4 receives this force to prevent the glass run GR from being damaged and also from flapping.

The design portion 21a of the inner member 21 and the design portion 22a of the outer member 22 are substantially flush with each other, and a garnish, serving as a decorative member, is mounted to the flush outer surfaces of the design portion 21a and the design portion 22a.

The vehicle-exterior-side extension portion 21b3 and the vehicle-exterior-side sheet-thickness end face 21b4 of the inner member 21 and the vehicle-exterior-side extension portion 22b3 of the outer member 22 constitute overlapped portions which overlap each other, and these overlapped portions form a vehicle-interior-side holding portion of the glass-run holding recess.

In the present embodiment, the vehicle-exterior-side extension portion 21b3 of the inner member 21, which is made of a plated steel sheet, and the vehicle-exterior-side extension portion 22b3 (the bent portion 22b4) of the outer member 22, which is made of a plated steel sheet, overlap each other and are joined together by laser welding.

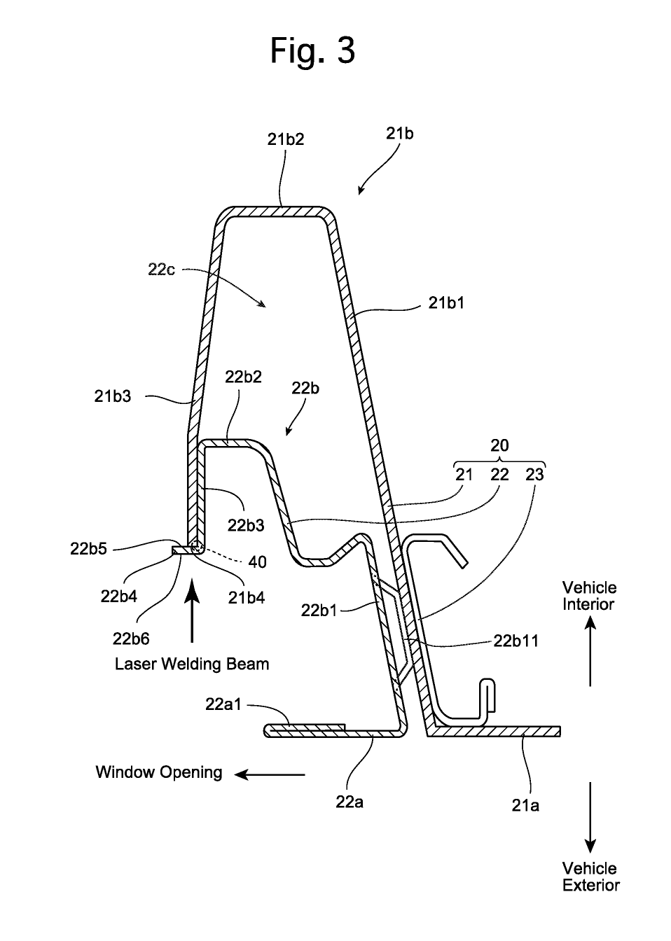

In the laser welding process, as shown in FIG. 3, the vehicle-exterior-side extension portion 21b3 of the inner member 21, which is made of a plated steel sheet, and the vehicle-exterior-side extension portion 22b3 of the outer member 22, which is made of a plated steel sheet, overlap each other, and the vehicle-exterior-side sheet-thickness end face 21b4 of the vehicle-exterior-side extension portion 21b3 is brought into contact with a vehicle-interior-side surface of the bent portion 22b4 of the vehicle-exterior-side extension portion 22b3. In this state, a laser-welding beam is applied to a vehicle-exterior-side surface 22b6 of the bent portion 22b4 from the vehicle exterior side. Thereupon, a vehicle-interior-side surface 22b5 of the bent portion 22b4 and the vehicle-exterior-side sheet-thickness end face 21b4 are melted and joined together, and contact portions 40 of the vehicle-exterior-side extension portion 21b3 and the vehicle-exterior-side extension portion 22b3 that are in contact with each other are melted and joined together. The weather strip retaining member 23 is welded to the vehicle-interior-side extension portion 22b1 of the outer member 22 after the vehicle-interior-side extension portion 21b1 and the plurality of welding seats 22b11 are welded.

Although the inner member 21 is made of a plated steel sheet, the vehicle-exterior-side sheet-thickness end face 21b4 (i.e., trim edge) thereof is not sufficiently plated (plating does not spread well thereon), and hence blowout does not easily occur when the vehicle-exterior-side sheet-thickness end face 21b4 is being welded, which improves the weldability of the vehicle-exterior-side sheet-thickness end face 21b4 and the bent portion 22b4, thus making it possible to achieve durable and high-precision welding. Welding marks created in this embodiment appear on the vehicle external side of the bent portion 22b4 and are therefore hidden by the glass run GW.

The emission direction (angle) and the emission position of a laser-welding beam are not limited to the above illustrated emission direction (angle) and emission position, but are optional within a range in which the bent portion 22b4 and the vehicle-exterior-side sheet-thickness end face 21b4 can be melted and joined together at the contact portions 40 and in which the vehicle-exterior-side extension portion 21b3 and the vehicle-exterior-side extension portion 22b3 can be melted and joined together at the contact portions 40. Additionally, a laser-welding beam can be applied from a surface of the vehicle-exterior-side extension portion 21b3 on the window opening side.

The vehicle-interior-side extension portion 21b1 of the outer member 21, which is made of a plated steel sheet, and the plurality of welding seats 22b11 of the outer member 22, which is made of a row steel sheet, can also be welded by a similar welding operation to the laser welding operation by which the vehicle-exterior-side extension portion 21b3 of the inner member 21 and the vehicle-exterior-side extension portion 22b3 of the outer member 22 are welded. The weather strip retaining member 23 is welded to the vehicle-interior-side extension portion 22b1 of the outer member 22 after the vehicle-interior-side extension portion 21b1 and the plurality of welding seats 22b11 are welded.

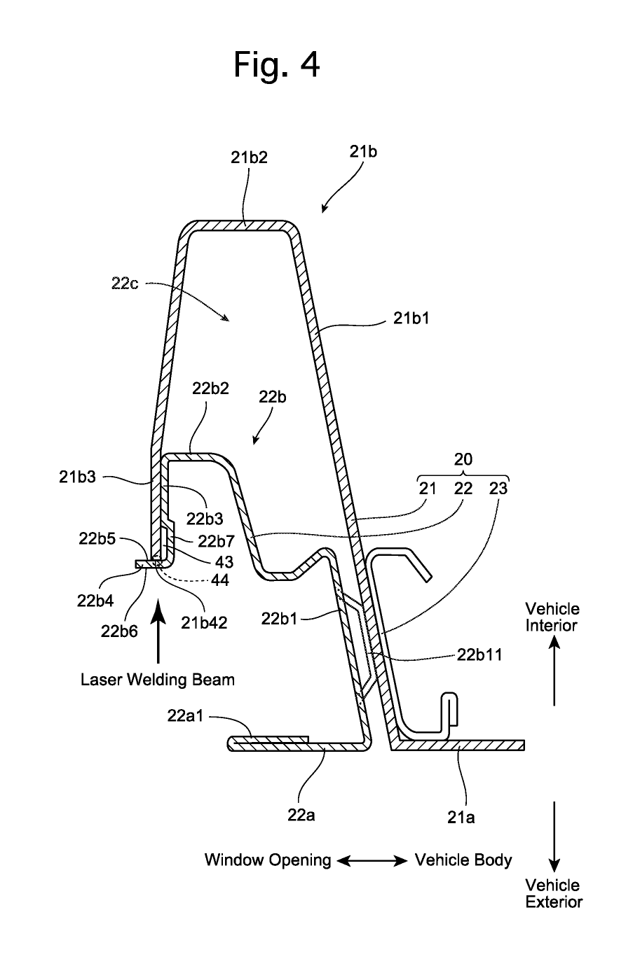

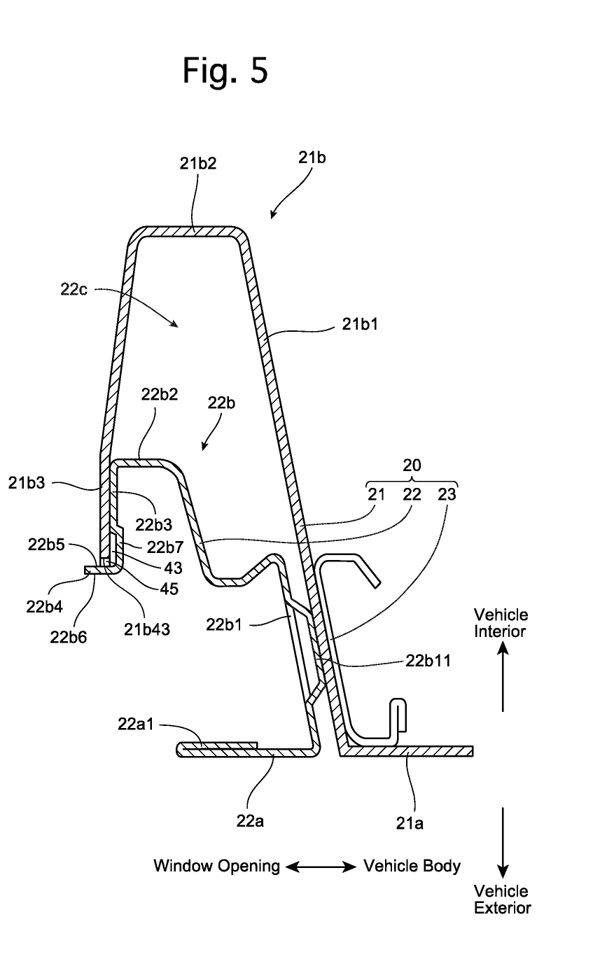

FIGS. 4 and 5 show cross sectional views of the second embodiment of the overlapped portions (overlapped sheet portions) of the inner member 21 and the outer member 22, taken at different positions in the vertical (up-down) direction. In the second embodiment, the vehicle-exterior-side extension portion 22b3 of the outer member 22 is firstly provided with a spaced portion 22b7 which is spaced from the vehicle-exterior-side extension portion 21b3 and thereafter provided with the bent portion (bent sheet portion) 22b4 that bends toward the window opening side from the spaced portion 22b7 to come in contact with vehicle-exterior-side sheet-thickness end faces 21b42 of the vehicle-exterior-side extension portion 21b3. A clearance 43 is formed between the spaced portion 22b7 and the vehicle-exterior-side extension portion 21b3. The end of the vehicle-exterior-side extension portion 21b3 of the inner member 21 is provided at predetermined intervals in the vertical direction with depressions and projections; the vehicle-exterior-side sheet-thickness end faces 21b42 which define the projections are made to contact the vehicle-interior-side surface 22b5 of the bent portion 22b4 (FIG. 4), and clearances 45 are formed between the vehicle-interior-side surface 22b5 of the bent portion 22b4 (FIG. 5) and the vehicle-exterior-side sheet-thickness end faces 21b43, which define the depressions.

In the second embodiment, a laser-welding beam is applied to contact portions 44 of the vehicle-interior-side surface 22b5 and the vehicle-exterior-side sheet-thickness end face 21b42, which are in contact with each other, from the vehicle-exterior-side surface 22b6 of the bent portion 22b4. Thereupon, the contact portions 44 of the vehicle-interior-side surface 22b5 of the bent portion 22b4 and the vehicle-exterior-side sheet-thickness end face 21b42 are melted and welded together.

In the second embodiment, since there is the clearance 43 between the vehicle-exterior-side extension portion 21b3 and the spaced portion 22b7 of the vehicle-exterior-side extension portion 22b3, the entire surface of each vehicle-exterior-side sheet-thickness end face 21b42 comes in contact with the vehicle-interior-side surface 22b5 of the bent portion 22b4, so that the contact state between the vehicle-exterior-side sheet-thickness end face 21b42 and the vehicle-interior-side surface 22b5 is well maintained. Additionally, in the second embodiment, since the clearances 45, through which the clearance 43 and the outside are communicatively connected, is provided between the vehicle-exterior-side sheet-thickness end face 21b43 and the vehicle-interior-side surface 22b5 of the bent portion 22b4, a molten layer that expands and melts at the contact portions 44 flows into the clearances 43 and 45 to thereby prevent the bent portion 22b4 and the vehicle-exterior-side extension portions 21b3 and 22b3 from being deformed; in addition, gas expanded in welding is discharged outside through the clearances 43 and 45 to thereby eliminate the possibility of blowout occurring. Welding marks created in the second embodiment appear on the vehicle external side of the bent portion 22b4 and are therefore hidden by the glass run GW.

The emission direction (angle) and the emission position of a laser beam are not limited to the above illustrated emission direction (angle) and emission position, but are optional within a range in which the bent portion 22b4 and the vehicle-exterior-side sheet-thickness end face 21b4 can be melted and joined together at the contact portions 44.

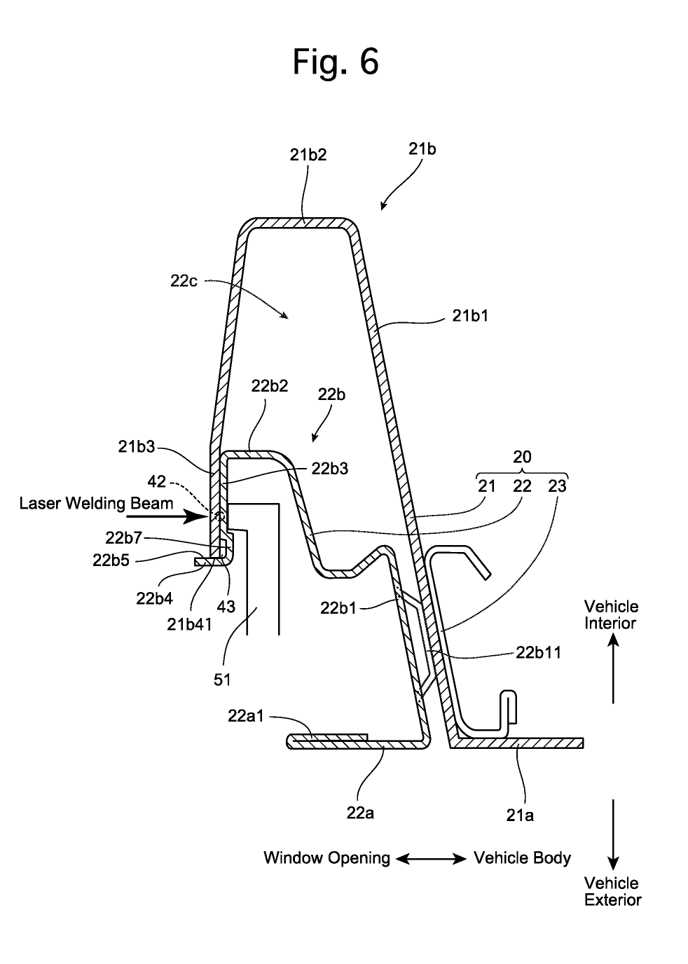

FIG. 6 shows the third embodiment in which a laser-welding beam is applied to a surface of the vehicle-exterior-side extension portion 21b3 on the window opening side (on the opposite side of the vehicle-exterior-side extension portion 21b3 from the outer member 22) from the window opening side. During this application, a jig 51 made of copper is made to abut against a surface of the vehicle-exterior-side extension portion 22b3 of the outer member 22 on the opposite side of the vehicle-exterior-side extension portion 22b3 from the vehicle-exterior-side extension portion 21b3 at a point which faces the point on the vehicle-exterior-side extension portion 22b3 to which the laser-welding beam is applied. Upon the laser-welding beam being applied with the jig 51 made to abut against the vehicle-exterior-side extension portion 22b3, the contact portions 42 of the vehicle-exterior-side extension portions 21b3 and 22b3 are melted and welded together. The jig 51 functions to absorb the heat in the melting, thus making it possible to reduce the possibility of blowout occurring.

In each of the above illustrated embodiments, upon each of the inner member 21 and the outer member 22 being formed from a plated steel sheet, the bent portion 22b4 and the vehicle-exterior-side sheet-thickness end face 21b4 are laser-welded with the vehicle-exterior-side extension portion 21b3 of the inner member 21 and the vehicle-exterior-side extension portion 22b3 of the outer member 22 that is made of a plated steel sheet overlapped onto each other, which makes it possible to achieve a vehicle door sash having a vertical pillar sash which is superior in outward appearance. According to the illustrated embodiments, a vehicle-interior-side holding portion of the glass-run holding recess can be formed without using hemming because the bent portion 22b4 of the outer member 22 and the vehicle-exterior-side sheet-thickness end face 21b4 of the vehicle-exterior-side extension portion 21b3 of the inner member 21 are laser-welded.

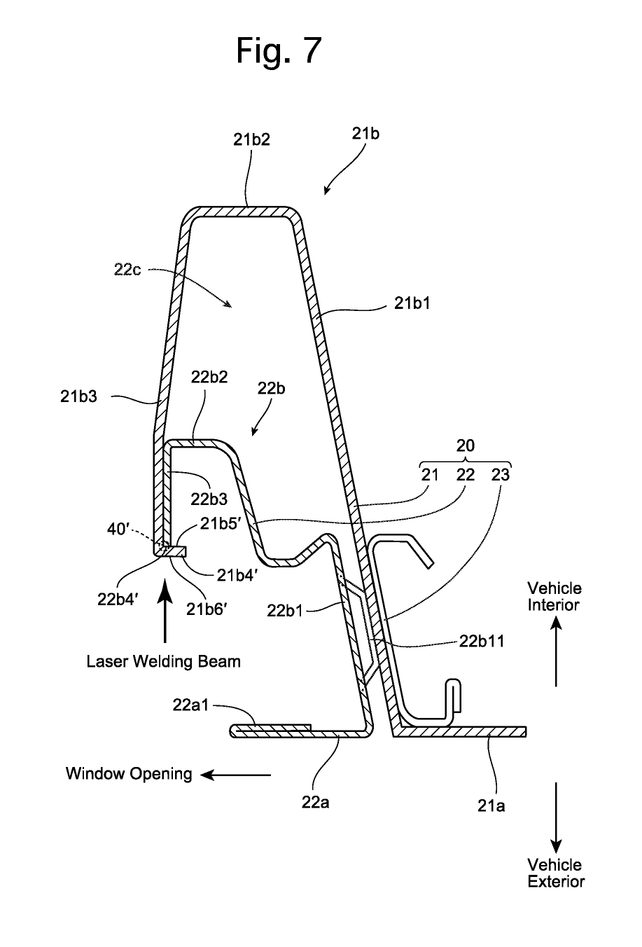

The bent portion 22b4 is formed on the outer member 22 in the above illustrated embodiments, whereas in the fourth embodiment shown in FIG. 7, a bent portion 21b4′ which bends toward the outer direction from the window opening is formed at the end of the vehicle-exterior-side extension portion 21b3 on the vehicle exterior side that forms the overlapped portion of the inner member 21, and a vehicle interior side surface 21b5′ of the bent portion 21b4′ adjacent to the outer member 22 is made to contact a vehicle-exterior-side sheet-thickness end face 22b4′ of the vehicle-exterior-side extension portion 22b3 that forms the overlapped portion of the outer member 22. A laser-welding beam is applied from a vehicle exterior surface 21b6′ of the bent portion 21b4′, which is positioned on the opposite side of the bent portion 21b4′ from the vehicle interior side surface 21b5′ so that the vehicle interior side surface 21b5′ of the bent portion 21b4′ and the vehicle-exterior-side sheet-thickness end face 22b4′ are melted and joined together, and so that contact portions 40′ of the vehicle-exterior-side extension portion 21b3 and the vehicle-exterior-side extension portion 22b3 that are in contact with each other are melted and joined together. The other structures are identical to those of the first embodiment shown in FIG. 3, and accordingly, elements which are identical to those of the first embodiment are designated by the same reference numerals.

In the second and third embodiments, it is possible to provide the inner member 21 with a bent portion and a spaced portion which are similar to the bent portion 22b4 and the spaced portion 22b7 that are formed on the outer member 22 and provide the outer member 22 with sheet-thickness end faces which are similar to the vehicle-exterior-side sheet-thickness end faces 21b42 and 21b43 that are formed on the inner member 21 to form clearances between the inner member 21 and the outer member 22 which are similar to the clearances 43 and 45.

### INDUSTRIAL APPLICABILITY

The vehicle vertical pillar sash according to the present invention is widely applicable to vehicle doors.

### REFERENCE SIGN LIST

B Vehicle body
BWS Body-side weather strip
DWS Door-side weather strip
GR Glass run
10 Vehicle door
11 Door body
12 Window opening
13 Door sash (Window frame)
14 Upper sash
16 Center pillar
20 Vertical pillar sash
21 Inner member
21a Design portion
21b Folded-back portion
21b1 Vehicle-interior-side extension portion
21b2 Forward/rearward extension portion
21b3 Vehicle-exterior-side extension portion (sheet portion extending toward the vehicle exterior side/overlapped portion)
21b4 21b42 21b43 Vehicle-exterior-side sheet-thickness end face
21b4′ Bent portion
21b5′ Vehicle interior side surface
21b6′ Vehicle exterior side surface
22 Outer member
22a Design portion
22b Folded-back portion
22b1 Vehicle-interior-side extension portion
22b2 Closed-cross-section (Pocket-like portion) forming portion
22b3 Vehicle-exterior-side extension portion (sheet portion extending toward the vehicle exterior side/overlapped portion)
22b4 Bent portion
22b5 Vehicle interior side surface
22b6 Vehicle exterior side surface
22b7 Spaced portion
22b4′ Vehicle-exterior-side sheet-thickness end face
22c Pocket-like portion
23 Weather strip retaining member
40 40′ 42 44 Contact portion
43 45 Clearance

1. A vehicle door sash having a vertical pillar sash and including an inner member and an outer member, on which overlapped portions are respectively formed to thereby form a pocket-like portion,
wherein one of said inner member and said outer member comprises a bent portion which is continuous with associated said overlapped portion,
wherein at least part of a sheet-thickness end face of the other of said inner member and said outer member is in contact with said bent portion, and
wherein said bent portion and said sheet-thickness end face are laser-welded at said contact portion.

2. The vehicle door sash having said vertical pillar sash according to claim 1, wherein said bent portion is formed on said outer member, and
wherein a welding area between said inner member and said outer member comprises contact portions of a surface of said bent portion of said outer member on said inner member side and said sheet-thickness end face of said inner member that are in contact with each other.

3. The vehicle door sash having said vertical pillar sash according to claim 1, wherein said bent portion is formed on said inner member, and
wherein a welding area between said inner member and said outer member comprises contact portions of a surface of said bent portion of said inner member on said outer member side and said sheet-thickness end face of said outer member which are in contact with each other.

4. The vehicle door sash having said vertical pillar sash according to claim 1, wherein at least one of said inner member and said outer member is made of a plated steel sheet.

5. The vehicle door sash having said vertical pillar sash according to claim 1, wherein a spaced portion, which causes said inner member and said outer member to be in noncontact with each other between said bent portion and said overlapped portions, is formed on said one of said inner member and said outer member that includes said bent portion, and
wherein said bent portion is bent and extends toward said other of said inner member and said outer member that does not include said bent portion from said spaced portion.

6. The vehicle door sash having said vertical pillar sash according to claim 1, wherein a contact portion and a noncontact portion which are in contact and noncontact with said bent portion, respectively, are formed on said sheet-thickness end face.
